(19) United States
(12) Patent Application Publication
(10) Pub. No.: US 2013/0192180 A1
(43) Pub. Date: Aug. 1, 2013

(54) FILTER ASSEMBLY

(71) Applicants: Thomas F. Walker, Algonquin, IL (US); Ronald J. Becker, Oak Park, IL (US); James A. Foote, Frankfort, IL (US)

(72) Inventors: Thomas F. Walker, Algonquin, IL (US); Ronald J. Becker, Oak Park, IL (US); James A. Foote, Frankfort, IL (US)

(73) Assignee: MPC INC., Wilmington, DE (US)

(21) Appl. No.: 13/636,880

(22) PCT Filed: Mar. 21, 2011
(86) PCT No.: PCT/US11/29173

§ 371 Date: Nov. 30, 2012

Related U.S. Application Data
(60) Provisional application No. 61/317,449, filed on Mar. 25, 2010.

(51) Int. Cl. B01D 46/00

(52) U.S. Cl. CPC B01D 46/0065; B01D 46/0068
USPC 55/300; 55/301; 55/295; 55/302; 55/511; 55/502; 55/497

(57) ABSTRACT

In accordance with one embodiment, a filter assembly includes a housing having an inlet for particulate laden gas and an outlet for clean gas. The assembly also has at least one filter being capable of filtering particulate from the gas that is located in the gas flow between the inlet and outlet. The filter assembly further includes a cleaning mechanism for removing particulate from the filter and the filter assembly.

### CROSS-REFERENCE TO RELATED APPLICATIONS

This application claims the benefit of U.S. Provisional Patent Application Ser. No. 61/317,449, filed Mar. 25, 2010, the disclosure of which is hereby incorporated by reference as if set forth in its entirety herein.

### BACKGROUND

Many industries utilize filter assemblies to clean air and related gases laden with dust or other particulate matter generated by industrial, commercial, or residential processes. Conventional filters have been provided in what are known in the art as “baghouses,” “cartridge collectors,” or “filterhouses.” Baghouse filters generally include a housing that contain one or more filter bags that receive dirty intake gas, remove particulate from the intake gas, and exhaust a clean gas having a reduced particulate content. A filterhouse filter generally includes a support structure that retains one or more filtration cartridges that are placed in an airflow path between a dirty gas intake and a clean gas exhaust. Such prior art devices have drawbacks in terms of size as well as maintenance and cleaning

One example of a conventional filter assembly includes round filter elements as disclosed in U.S. Pat. No. 4,395,269. Unfortunately, conventional filter assemblies can require time and labor intensive procedures to clean and maintain. Furthermore, while filter assemblies with round filter elements can be designed to be relatively compact, it is desirable to design filter assemblies to provide filtration in even smaller spaces. Moreover, it has been found that round filter elements and other types of non-symmetrical surface loading elements produce turbulent airflow, thereby adversely affecting the filtration efficiency.

What is therefore desired is a filter assembly that overcomes the shortcomings of conventional filtration assemblies.

### SUMMARY

This Summary is provided to introduce a selection of concepts in a simplified form that are further described below in the Detailed Description of Illustrative Embodiments. This Summary is not intended to identify key features or essential features of this invention, nor is it intended to be used to limit the scope of the invention.

According to one embodiment, a gas filter assembly includes a housing having an inlet for particulate-laden gas and an outlet for clean gas. The assembly also has at least one filter element capable of filtering particulate from the gas that is located in the gas flow between the inlet and the outlet. The filter element comprises approximately planar filter media oriented substantially vertically and defining a space forming a passage for cleaned gas. Particulate-laden gas flows through the inlet to the filter element. As gas flows through the filter media in the filter element, the particulates are removed from the flow creating clean gas by reducing the particulate count. The clean gas then flows out of the gas filter assembly through the outlet.

The gas filter assembly further includes a cleaning mechanism for removing particulate matter from the planar filter media and a sealed outlet into which removed particulate can be discharged. In this embodiment, particulates are dislodged from the filter media by compressed gas that passes through pulse nozzles. Gravity then forces the particulates to drop away from the filter media to the sealed outlet for the removal of the particulates from the gas filter assembly.

Additional features and advantages will be made apparent from the following detailed description of illustrative embodiments that proceeds with reference to the accompanying drawings.

### BRIEF DESCRIPTION OF THE DRAWINGS

Preferred embodiments of the invention will now be described by way of example with reference to the accompanying drawings, wherein:

FIG. 1 is a front elevation view of a filter assembly including a plurality of filter elements retained in a filter housing in accordance with one embodiment;

FIG. 2 is a side elevation view of the filter assembly illustrated in FIG. 1, with portions broken away;

FIG. 3 is a top plan view of the filter assembly illustrated in FIG. 1;

FIG. 4A is a perspective view of one embodiment of a portion of one of the filter elements illustrated in FIG. 1;

FIG. 4B is a perspective view of a plurality of filter elements disposed in the filtration chamber;

FIG. 5 is a sectional side elevation view of the housing component illustrated in FIG. 1; and

FIG. 6 is a sectional top plan view of the housing illustrated in FIG. 5, taken along line 6-6.

### DETAILED DESCRIPTION

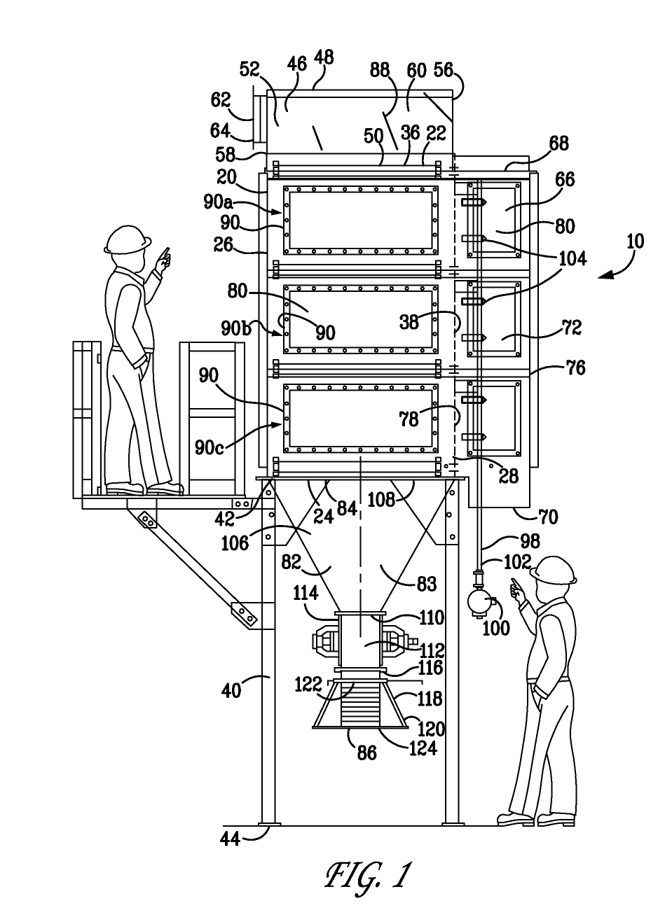

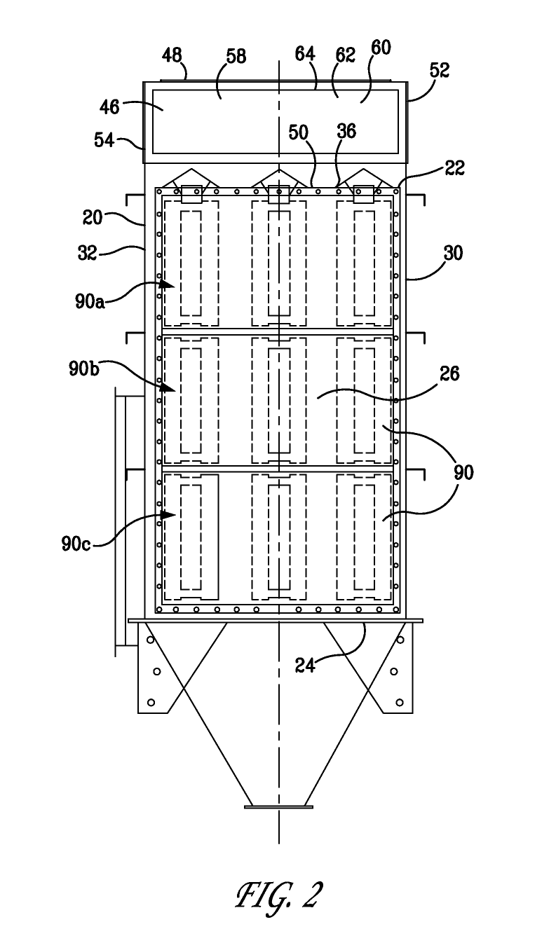

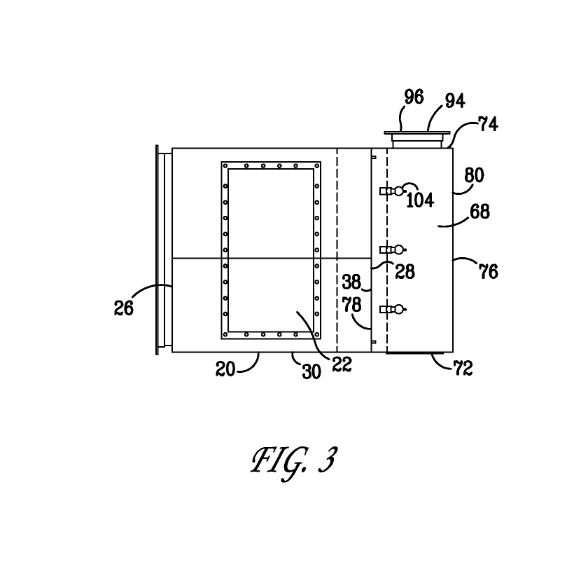

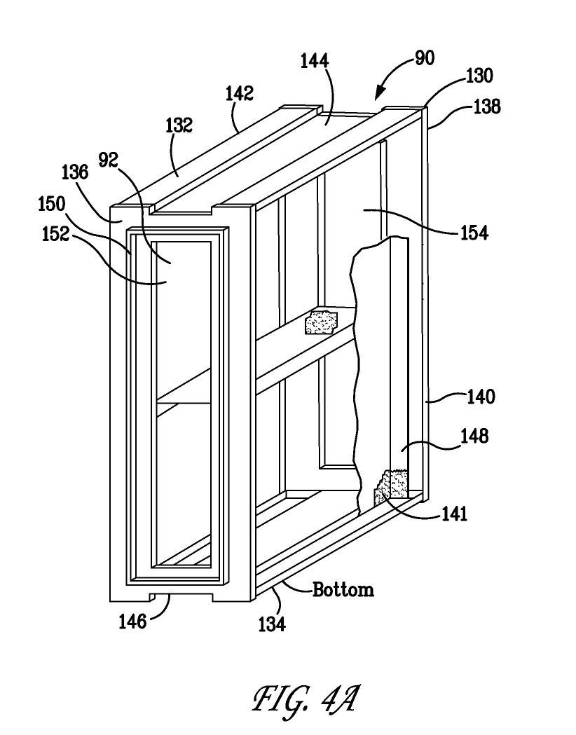

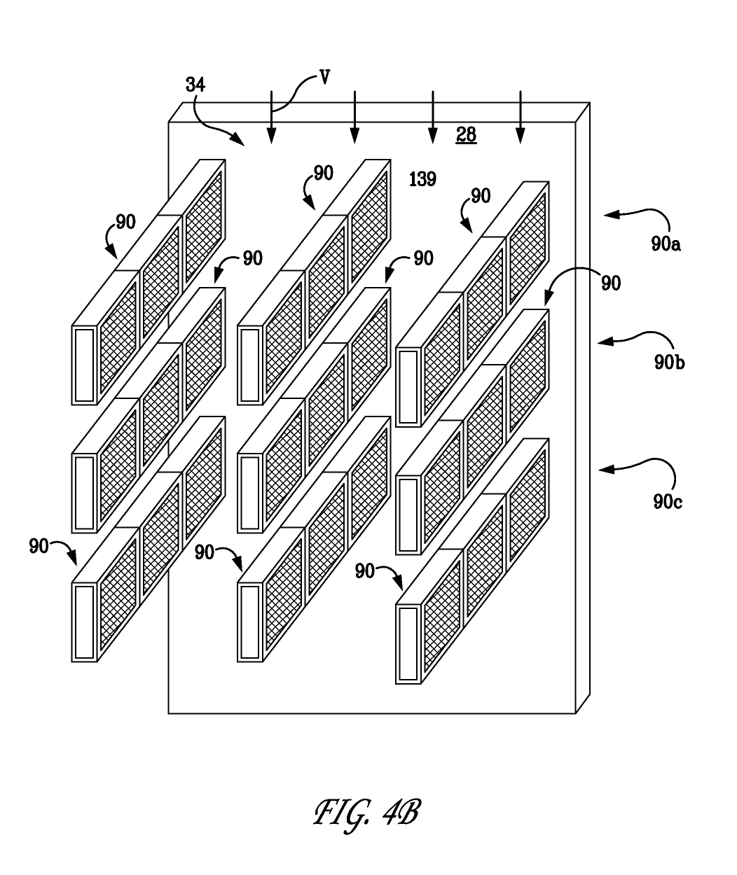

Referring to FIGS. 1-3, a gas filter assembly is illustrated as it might appear in an industrial plant setting. In accordance with the illustrated embodiment, the gas filter assembly 10 includes a housing 20 that includes a top wall 22, a bottom wall 24, opposing side walls, 26 and 28, a front wall 30, and a back wall 32 that collectively define an inner space 34 of housing 20. Wall 28 is also referred to herein a plenum wall The inner space 34 (see FIG. 4B) provides a filtration chamber that retains a plurality of filter elements 90 arranged in three vertically spaced rows 90A, 90B, and 90C including three vertically aligned filter elements 90 in each row, though it should be appreciated that the filter assembly can include any number of filter elements 90 arranged as desired. It should be appreciated that the housing 20 can be constructed having any suitable size and shape as desired. The gas filter assembly 10 can further include a support structure in the form of posts having an upper end 42 that connects to the bottom wall 24 of housing 20, and a lower end 44 that rests on a support surface, such as a floor.

The housing 20 defines a gas inlet 36 that is in fluid communication between a source of contaminated air and the filtration chamber 34, and a gas outlet 38 that is in fluid communication with an interior space, such as an interior space of a building. The gas inlet 36 extends through the top wall 22, and the gas outlet 38 extends through the side wall 28, though it should be appreciated that the inlet and outlet can be positioned anywhere in the housing 20 as desired such that contaminated air is directed from the inlet 36 through one or more filter elements 90, and clean air is expelled through the outlet 38. It should be appreciated that the clean air has a particulate content (which may or may not be zero) that is less than the particulate content of the contaminated, or dirty, air.

The gas filter assembly 10 can also include a gas intake manifold 46 having a top wall 48, a bottom wall 50, a front wall 52, a back wall 54, and opposing side walls 56 and 58 that cumulatively define an interior space 60. It should be appreciated that the manifold 46 can be constructed having any suitable size and shape as desired. It should be appreciated that while adjacent structure of the gas filter assembly 10 are described as including separate adjacent walls herein, it should be appreciated that the adjacent structure can also be said to share a common wall. The top wall 22 of the housing is connected to the bottom 50 of gas intake manifold 46. The bottom 50 of the manifold 46 can define an opening that is in fluid communication with the inlet 36 of the housing 20 when the manifold 46 is connected to the housing 20. The side wall 58 of the gas intake manifold 46 defines a manifold inlet 62 that receives particulate laden gas. The manifold 46 includes a lip 64 that defines the inlet into the interior space 60. The lip 64 can be connected to a conduit (not shown) for transfer of particulate laden gas to the filter assembly 10. The particulate laden gas then travels from the manifold through the inlet 36 of the housing 20, and into the filtration chamber 34.

The gas intake manifold 46 further includes one or more baffles 88 disposed in the inner space 60 and connected between opposing walls of the manifold 46, for instance the front and back walls 52 and 54. Baffles 88 may be straight as shown in FIG. 1, or curved as desired. The baffles 88 are angled relative to the flow of the particulate laden intake gas, and thus direct the flow from the manifold inlet 62 through the inner space 60 of inlet manifold 46 to the filtration chamber 34 of the housing 20.

The gas filter assembly 10 further includes a clean gas plenum 66 having a top wall 68, a bottom wall 70, a front wall 72, a back wall 74, and opposing side walls 76 and 78 that cumulatively define an interior space 80. It should be appreciated that the plenum 66 can be constructed having any suitable size and shape as desired. The outlet 38 of housing 20 is in fluid communication with an opening in the side wall 78 of the plenum 80, and thus is in fluid communication with the interior space 80. The clean gas plenum 66 further defines a gas outlet 94 which may be connected to a conduit (not shown) for the transfer of clean exhaust gas away from the filter assembly 10 and into the ambient environment or other downstream gas process equipment.

Gas filter assembly 10 further includes a discharge system 82 having an upper end 84 that is in fluid communication with an opening formed in the bottom wall 24 of the housing 20, and a lower end 86 that is in fluid communication with any desired waste collection site. In the illustrated embodiment, the discharge system 82 includes a hopper 106 which has an inlet 108 and outlet 110. The inlet 108 is defined by the top 84 of discharge system 82, and connects to the bottom 24 of housing 20. One of skill in the art will recognize that the hopper 106 can be replaced with any collection device for collecting the particulates.

In accordance with the illustrated embodiment, the discharge system 82 also includes gas lock 112 having a top end 114 and a bottom end 116. The hopper outlet 110 connects to top 114 of gas lock 112, which can be sealed to prevent the backflow of atmospheric or downstream process gases into the filtration chamber 34.

The discharge system 82 further includes any suitable conventional outlet 118 which is defined by joint 120 as illustrated. The joint 120 has a top end 122 and a bottom end 124. The bottom end 116 of the gas lock 112 connects to the top end 122 of the joint 120.

During operation of the filter assembly 10, particulates that are filtered from the filter elements 90 in the filtration chamber 34 pass through hopper inlet 108 into hopper 106 and through hopper outlet 110 to the top end 114 of the gas lock 112. The gas lock 112 prevents ambient gas from passing into the gas filter assembly 10. The gas lock 112 can be actuated periodically to allow the filtered particulates to pass from the top end 114 of the gas lock 112 through the gas lock 112 and out the bottom end 116 into a joint 120.

In accordance with the illustrated embodiment, the joint 120 is provided as an expansion joint and cover. The joint 120 allows for the attachment of a container (not shown) such as a steel drum for collecting and disposing of particulates passing though the discharge system 82.

With continuing reference to FIGS. 1-3, the filter elements 90 are supported in the filtration chamber 34 of the housing 20. While the filter elements 90 are removable as illustrated, it should be appreciated that one or more of the filter elements 90 can also be permanently affixed within the housing. Accordingly, in yet another embodiment, the filter assembly 10 may comprise filter elements that are permanently affixed and others that are removable.

Referring also to FIG. 4A, at least one up to all of the filter elements 90 includes a frame 130 having a top wall 132, a bottom wall, 134, an open front end 140, an open back end 142, and opposing side walls 136 and 138. Filter media 139 (see FIG. 4B) is disposed in the open front and back ends 140 and 142, so as to close the front and back ends. Filter media 139 fits in to filter media support 141. The filtration media 139 can have a porosity that allows particulate laden gas, such as air, to travel through the front and back ends 140 and 142. The filter element 90 thus defines an internal filter channel 92 defined by the frame 130 and filter media. The internal filter channel 92 is defined by an opening 152 extending through the side wall 136 of the filter element 90, an opposing opening 154 extending through the opposing side wall 138, and an interior space disposed between the front and back ends 140 and 142. Each filter element 90 can include one or more frames 130. The side wall 136 contains a gasket 150 that facilitates connection of adjacent frames 130. Opposing side wall 138 also contains a similar, but differently dimensioned gasket such that there is a larger gasket one on one side and a smaller on the other side so that the gaskets nest and form a seal when adjoined.

While each filter element 90 includes opposed openings 152 and 154, it should be appreciated that a single filter element 90 can include one opening 152 that receives filter media 139, such that a pair of filter elements 90 can be placed adjacent each other so as to cumulatively define an internal channel 92. Thus, the filter assembly 10 includes at least one filter element that defines an internal channel 92.

The top 132 and bottom 134 of filter element 90 contain grooved cutouts 144 and 146, respectively. The left side 136 and right side 138 contain potting material 148 which fastens top 132, bottom 134, front 140, and back 142. Filter media 139 fits within the front side 140 and back side 142. It will be appreciated that the frame on the downstream side of the filter media may be expanded to supply greater support to the filter media. In an alternative embodiment, filter media may be one piece that wraps around or fits in frame 130. In another alternative embodiment, filter element 90 may hold only one piece of approximately planar filter media oriented substantially vertically. In this alternative embodiment, at least two filter elements 90 are positions opposite each other in housing 20 to form, in part, internal filter channel 92.

The filter media 139 can include or woven media, spun bond, polyester, polypropylene, aramid, fiberglass, etc with various chemical treatments to suit applications. Additionally, membrane laminates or nano fiber materials may be used. Furthermore, the filter media 139 can be pleated or unpleated.

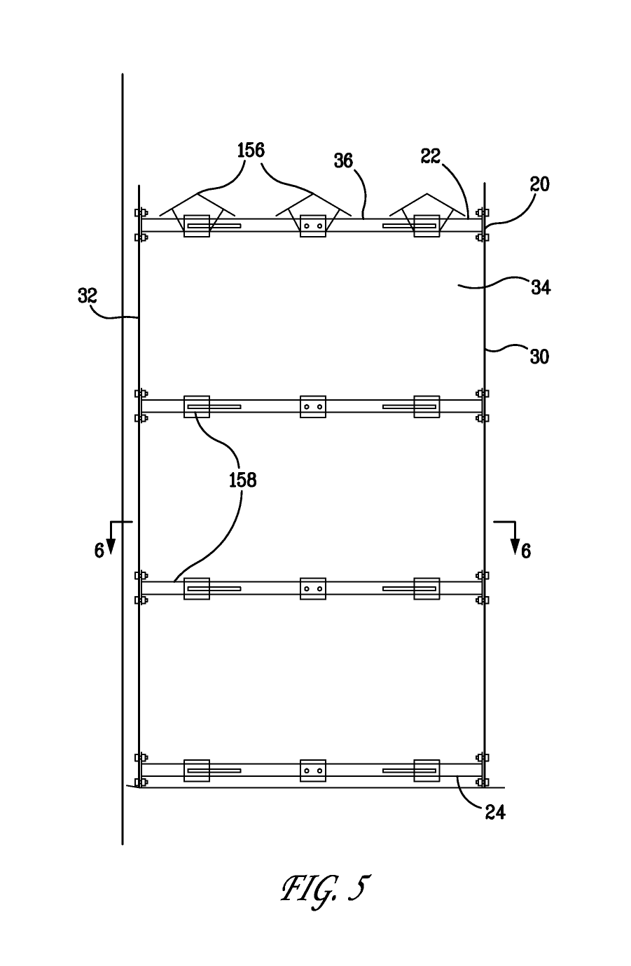

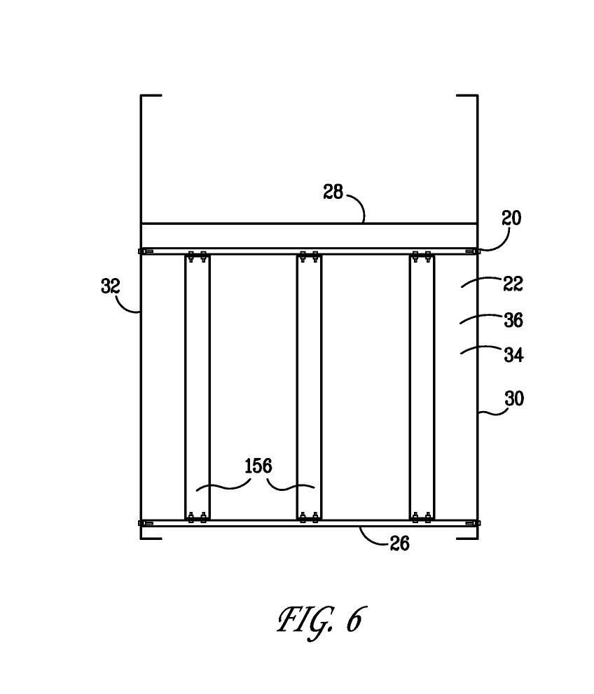

Referring to FIGS. 5 and 6, the top 22 of housing 20 contains diverter plates 156 that sit below the baffles 88 contained within the gas intake manifold 46, and are disposed above filter elements 90.

Cartridge alignment tubes 158 run horizontally between the opposing side walls 26 and 28 of the housing 20 at a location below the diverter plates 156. The cartridge alignment tubes 158 are substantially rectangular in cross section. The dimensions of the tubes 158 correspond to the dimensions of cutouts 144 and 146 of the top 132 and bottom 134 of filter element 90. It will be appreciated by one of skill in the art that the alignment tubes 158 may be structured to be of any suitable cross section to correspond to the cutouts 144 and 146. For example, cutouts 144 and 146 may be rounded in the shape of a semi-circle or a semi-oval. In this alternative embodiment, alignment tubes 158 may have a circular or ovular shape. It will be further understood by one of skill in the art that the cutouts 144 and 146 do not have to directly correspond in shape to the cross sections of tubes 158. In yet another embodiment, cutouts 144 and 146 may be rectangular while tubes 158 may have ovular cross sections, or vice versa.

In the present embodiment, filter elements 90 may be configured to be removable from the housing 20. As explained earlier, filter assembly 10 may comprise removable filter elements 90 or filter elements 90 may be permanently affixed within the housing 20. Additionally, another alternative embodiment includes a combination of filter elements that are permanently affixed and removable. Prior to use of the gas filter assembly 10, filter elements 90 are slid into the housing 20 on cartridge alignment tubes 158. If the filter elements 90 are configured to be removable, they can be slid out of the housing 20 when the gas filter assembly 10 is not in use. In an alternative embodiment, filter elements 90 may be secured to housing 20 so that the filter elements 90 are not removable by hand. The tubes 158 also provide support for the filter elements 90. In the present embodiment, housing 20 contains multiple rows (not shown) of filter elements 90 within housing 20 and multiple filter elements 90 within each row.

Referring also to FIGS. 1 and 4A-B, when multiple filter elements 90 are placed within rows 90A-90C, the gasket 150 on the front 140 of each filter element 90 nests with a corresponding gasket on the back 142 of the adjacent filter assembly (not shown) so that the gaskets do not cross each other and seal. This configuration aligns the internal filter channels 92 of each filter element 90. Each filter element 90 includes three adjacent frames 130 that collectively define opposing openings 152 and 154. It should be noted that alternative embodiments may include any number of rows or columns of frames. For example, an alternate embodiment may have 1, 2, or 4 or more rows of frames. The opening 152 is sealed by a gasket 150 against the side wall 26 (such as door 26), which can be provided as a door that provides selective access to the filtration chamber 34. The opening 154 is in fluid communication with an opening extending through the side wall 28, such that the internal channel 92 of each filter element 90 is in fluid communication with the clean gas plenum 66. A gasket 150 seals its filter element against plenum wall 28. Accordingly, when wall 26 is a door, the filter element of row 90 is sealed against the inside surface of door 26 and the opposing end of row 90 is sealed against plenum wall 28.

During operation, particulate laden gas, or dirty gas, such as air, travels from the gas inlet 36 in a vertically downward direction as indicated by Arrows V into the filtration chamber 34. Because both walls 26 and 28 are sealed against the filter elements 90, a differential pressure is thereby induced in the filtration chamber 34 that causes the dirty gas to travel through the filter media 139, which removes a quantity of particulate matter from the inlet gas stream. Notably, in an alternative embodiment, negative pressure may be induced into internal channel 92 to pull gas from filtration chamber 34 through filter media 139. The clean gas, which has a lower particulate count than the particulate laden gas, travels into the internal channel 92 of the respective filter element 90, and then travels out the filter element into the clean air plenum 66. The pressure on the clean side of the filter element is lower than the pressure on the dirty side of the filter element regardless of positive or negative pressure as compared to atmospheric pressure or as read on a gauge.

The filter media 139 of one or more up to all filter elements 90 is approximately planar and is oriented substantially vertically. Otherwise stated, the filter media 139 has a curvature that is less than that of an oval along the filter media 139 in the vertical direction. In accordance with the illustrated embodiment, the filter media 139 extends in a vertical direction. Accordingly, it has been found that the filter media 139 achieve more uniform filtration with respect to conventional filter elements that have a round surface (for instance, oval-shaped or more round than oval-shaped) with respect to a vertical direction along the filter media. Conventional filter pleats run horizontally, and are curved vertically.

In accordance with the illustrated embodiment, the clean gas plenum 66 further includes a compressed gas cleaning system 98. It will be appreciated by those of skill in the art that various types of cleaning systems may be used, and that the filter assembly 10 is not intended to be limited to the cleaning system 98 described herein. In one embodiment, the cleaning system may be mechanical. A mechanical cleaning system may comprise a rapper, socis, or shaker type configuration. The cleaning system may also be a reverse air type. A reverse air type cleaning system may comprise a blower type or a pulse jet type.

The present embodiment depicts a pulse jet type cleaning system. The compressed gas cleaning system 98 comprises a compressed gas header 100 configured to apply an inlet flow of compressed gas pressurized by an external source (not shown). The compressed gas cleaning system 98 further includes a compressed gas pipe 102 having pulse nozzles 104 that are connected to the gas header 100. Each pulse nozzle 104 is directed into the airflow channel 92 of a respective filter member 90. When applied, the compressed gas provides a temporary blast of air that travels from the channel 92 into the filtration chamber 34 that forces particulate matter off the filter media 139. The particulates are thus removed from the filter media 139, and falls under gravitational forces to the discharge system 82. Because the filter media 139 is oriented substantially vertically, lower positioned filter members 90 interfere less (or not at all) with particulates falling from upper filter members 90 with respect to conventional filter members whose filter members are outwardly rounded. Additionally, it has been found that prior art outwardly rounded filter members produce turbulent airflow, and that the substantially planar and substantially vertical filter media 139 produces an airflow that is more laminar with respect to conventional filter assemblies

It should be appreciated that several example embodiments of a filter assembly have been described, and that the described examples have been provided for the purpose of explanation and is not to be construed as limiting the invention. For instance, while embodiments have been presented including a gas intake manifold and a clean gas plenum, it should be appreciated that the filter assembly may or may not include either of these structures.

Although the filter assembly 10 has been described with reference to preferred embodiments or preferred methods, it is understood that the words which have been used herein are words of description and illustration, rather than words of limitation. Furthermore, although the filter assembly 10 has been described herein with reference to particular structure, methods, and embodiments, the embodiments are not intended to be limited to the particulars disclosed herein, as the invention extends to all structures, methods and uses that are within the scope of the present invention. Those skilled in the relevant art, having the benefit of the teachings of this specification, may effect numerous modifications to the invention as described herein, and changes may be made without departing from the scope and spirit of the invention.

What is claimed:

1. A gas filter assembly for filtering gas laden with particulate matter, the gas filter assembly comprising:
a housing having an inlet for particulate-laden gas, and an outlet for clean gas flow;
a plurality of filter elements capable of filtering particulate from the gas, the filter elements located in the gas flow between the inlet and the outlet;
at least one of the filter elements includes a frame having a top wall, a bottom wall, a front end extending between the top and bottom walls, a back end extending between the top and bottom walls, and a pair of opposing side openings disposed between the front and back ends;
filter media disposed at the front end and back end to form opposing planar sides of the filter media;
a passage for cleaned gas defined by and between the opposing planar sides of the filter media;
a cleaning mechanism that removes particulate matter from at least one of the planar filter media; and
a sealed outlet into which removed particulate can be discharged.

2. The assembly in accordance with claim 1, wherein the cleaning mechanism is mechanical

3. The assembly in accordance with claim 2 wherein the mechanical cleaning mechanism comprises a rapper, a socis, a shaker, or brushes.

4. The assembly in accordance with claim 1 wherein the cleaning mechanism is reverse air type.

5. The assembly in accordance with claim 4 wherein the reverse air cleaning mechanism is a pulse jet or blower type.

6. The assembly in accordance with claim 1 wherein the filter element has a plurality of sides and the filter element contains a gasket on one side and a corresponding gasket on the opposing side wherein the two gaskets are dimensioned to form a seal with one another.

7. A filter element for filtering gas laden with particulate matter, the filter element comprising:
a frame having a top wall, a bottom wall, a front end extending between the top and bottom walls, a back end extending between the top and bottom walls, and a pair of opposing side openings disposed between the front and back ends;
filter media disposed at the front end and back end to form opposing planar sides; and
an internal clean gas channel that extends between the opposed side openings at a location defined by and between the opposing planar sides of the filter media.

8. The assembly in accordance with claim 1 or 7 wherein the filter element is a removable cartridge.

9. The assembly in accordance with claim 7 wherein the frame has a gasket on one side and a corresponding cutout on the opposing side such that the gasket is adapted for mating to a cutout of an adjacent filter element.

10. The assembly in accordance with claim 1 or 7 wherein the filter media is pleated.

11. The assembly in accordance with claim 10 wherein the filter media pleats are vertically oriented.

12. The assembly in accordance with claim 7 wherein the frame on the downstream side of each filter media is expanded to support the filter media.

13. The filter element of claim 7 wherein the frame is an assembly including sides, a top, and a bottom, the frame including alignment grooves adapted for mating to supports on a baghouse structure.

14. The assembly of claim 1 wherein the filter elements are oriented in rows, a first end of the row forming a seal with a plenum wall and a second, opposing end of the row forming a seal with a baghouse door.
